(19) United States
(12) Patent Application Publication
(10) Pub. No.: US 2004/0177044 A1
(43) Pub. Date: Sep. 9, 2004

(54) Processing of copy control information for digital rights management

(75) Inventor: Petr Peterka, San Diego, CA (US)

Correspondence Address: CARPENTER & KULAS, LLP, 1900 EMBARCADERO ROAD, SUITE 109, PALO ALTO, CA, 94303, US

(73) Assignee: GENERAL INSTRUMENT CORPORATION, Horsham, PA (US)

(21) Appl. No.: 10/758,694

(22) Filed: Jan. 14, 2004

Related U.S. Application Data
(60) Provisional application No. 60/451,743, filed on Mar. 3, 2003.

(51) Int. Cl. G06F 17/60

(52) U.S. Cl. 705/57; 705/1

(57) ABSTRACT

A system for processing copy control information in a digital rights management system in standard languages such as XML, XrML and ODML. Concise and descriptive schemas are provided that provide differing levels of compactness and readability. In one embodiment, default values are used so that all attribute values do not have to be provided by a digital rights management definition author. Abbreviated descriptive names can be used along with value aliases to provide readily understandable definitions.

This application claims priority from U.S. Provisional Patent Application Serial No. 60/451,743 filed on Mar. 3, 2003 entitled “ENCODING OF EXTENDED COPY CONTROL INFORMATION IN EXTENSIBLE MARKUP LANGUAGE” that is hereby incorporated for reference as if set forth in full in this document for all purposes.

### BACKGROUND OF THE INVENTION

This invention relates in general to digital rights management and more specifically to encoding and processing of copy control information such as Extended Copy Control Information (ExCCI) within standardized formats such as Extensible Markup Language (XML).

Digital rights management (DRM) allows restricting the use of digital content. Digital content can include images, audio, text, data file, executable code or other information in a digital format. For example, a digital video of a movie includes images and audio and can be encoded, e.g., in a digital format such as Motion Pictures Expert's Group (MPEG) format. The digital video can be sold, licensed or otherwise made available to an end user by authorizing, or granting, rights to the user.

One early approach to DRM included Copy Control Information (CCI). The initial format of CCI is just two bits set to enforce content rights related to copy protection. Typically the bits are read by hardware or software such as a playback device, CDROM or DVD copier, computer, transfer device, etc. The CCI bits are indicators that can be set to indicate that (1) copying is not controlled, (2) only one copy could be made, (3) no more copies could be made, or (4) no copies could ever be made. The CCI bits were kept in association with the content, such as by putting the CCI bits on the same Compact Disc Read Only Memory (CDROM) or Digital Versatile Disc (DVD) as the content, or embedding the CCI bits in a stream of information used to deliver the content.

Extended CCI (ExCCI) is being developed to provide more bits and indicators to indicate more options related to access control for DRM. For example, ExCCI can restrict whether analog and/or digital signal representing the content can be output to an external destination. ExCCI also allows content to be used (e.g., viewed or played back) for a limited number of times. The restrictions can be time-based such as allowing the user to view the video over a period of time, preventing playback until after an initial waiting period has gone by, limiting the amount of time a video or audio playback can be paused, etc. ExCCI can also be used to control the user's ability to transfer the video or to make copies of the video, and to provide other controls. Up to 64 bytes are used to define ExCCI with the possibility of extending the definitions further, in customized applications. Details of CCI and ExCCI can be found, for example, at the web site of the Motion Picture Association of America, Copy Protection Technical Working Group at http://www.cptwg.org/Assets/September%20presentations/ExCCI_CPTWG1.ppt

Other approaches to access and control systems for DRM include full rights expression languages such as Extensible Rights Markup Language (XrML) and Open Digital Rights Language (ODRL). See, e.g., http://www.xrm1.org/and http://odr1.net/1.0/ODRL-10.pdf, respectively. (NOTE: These two are XML language as well.) While these approaches provide yet more flexibility in defining digital rights and supporting DRM, they also are larger and take up more room and processing resources in hardware devices such as playback or transfer devices. Also, their definitions can be large and cumbersome to work with for a human author or reader of the language definitions. It is desirable to provide a DRM system that allows readability, extensibility and interoperability.

One language that provides extensibility and interoperability is referred to as Extensible Markup Language (XML). FIG. 1 illustrates basic constructs of XML. In FIG. 1, line 10 is called the XML declaration. It is usually required as the first line in the document, or definition, to identify the document as an XML type. The declaration also defines the XML version of the document. In this case the document conforms to the 1.0 specification of XML.

XML uses elements defined by starting and ending tags. In FIG. 1, line 12 shows a tag labeled “note” that defines the first, or root, element. A tag is typically a label enclosed in angle brackets. So, for example, “<note>”, would be a legitimate tag. The end of the note element is signified by the ending tag which is the same as the starting tag except for a slash preceding the label. The ending tag for the root node note is shown at line 20 as “</note>”.

The note element also includes an attribute called “date”. Attributes are defined within the angle brackets of an element starting tag for the element to which the attributes are associated. Attributes can have a value that is assigned to the attribute by the use of the “=” symbol followed by the value in quotes. So, as shown at line 10, the date attribute has the value “Apr. 25, 2001”.

Another element is defined at line 14. This element has the name “to” and has the data “Ann”. An element's data is enclosed within the starting and ending tags, not within the tag itself—which is how the attribute/value pairs are stored. The “to” element is referred to as a “child” of the “note” element. The “note” element is the “parent” of the “to” element. Other elements that are child elements of the note element are the “from,” “heading” and “body” elements. The “to,” “from,” “heading” and “body” elements are called “siblings” of each other. In general, any number of elements can be contained within, or be data associated with, a parent element. Also, any number of attributes and values can be included within the starting tag of an element.

### SUMMARY OF THE INVENTION

A preferred embodiment provides a system for processing copy control information in a digital rights management system in standard languages such as XML, including variants and extensions such as XrML and ODML. Concise and descriptive schemas are provided that provide differing levels of compactness and readability. In one embodiment, default values are used so that all attribute values do not have to be provided by a digital rights management definition author. Abbreviated descriptive names can be used along with value aliases to provide readily understandable definitions.

In one embodiment the invention provides a system for processing copy control information in a digital rights management system in standard languages such as XML. Concise and descriptive schemas are provided that provide differing levels of compactness and readability. In one embodiment, default values are used so that all attribute values do not have to be provided by a digital rights management definition author. Abbreviated descriptive names can be used along with value aliases to provide readily understandable definitions.

In another embodiment the invention provides a method for writing a definition of extended copy control information (EXCCI) in a language, the language comprising elements having data, and further comprising attributes associated with an element, wherein an attribute can have an associated value, the ExCCi including indicators, the method comprising using the attributes to represent a substantial amount of the ExCCI indicators to define a schema of ExCCI in the language; and using the schema to create an ExCCI definition wherein the ExCCI indicators are assigned values.

### BRIEF DESCRIPTION OF THE DRAWINGS

FIG. 1 is a prior art illustration of basic constructs of XML;

FIG. 2 is a graphical depiction of processing an ExCCI definition in an XML format;

FIG. 3 is a first portion of an ExCCI schema in XML;

FIG. 4 is a second portion of an ExCCI schema in XML;

FIG. 5 is a third portion of an ExCCI schema in XML;

FIG. 6 is a fourth portion of an ExCCI schema in XML,

FIG. 7 shows an XML file defined using the schema of FIGS. 3-6

FIG. 8 is a first portion of a descriptive ExCCI schema;

FIG. 9 is a second portion of a descriptive ExCCI schema;

FIG. 10 is a third portion of a descriptive ExCCI schema;

FIG. 11 illustrates an ExCCI definition written using the ExCCI schema of FIGS. 8-10;

FIG. 12 is a graphical depiction of ExCCI rights associated with digital content as specified by an XML schema in FIGS. 8-10;

FIG. 13 shows a first portion of a data type definition extended to support ExCCI;

FIG. 14 shows a second portion of a data type definition extended to support ExCCI; and

FIG. 15 is an example of an XML encoding based on the data type definition from FIGS. 13-14.

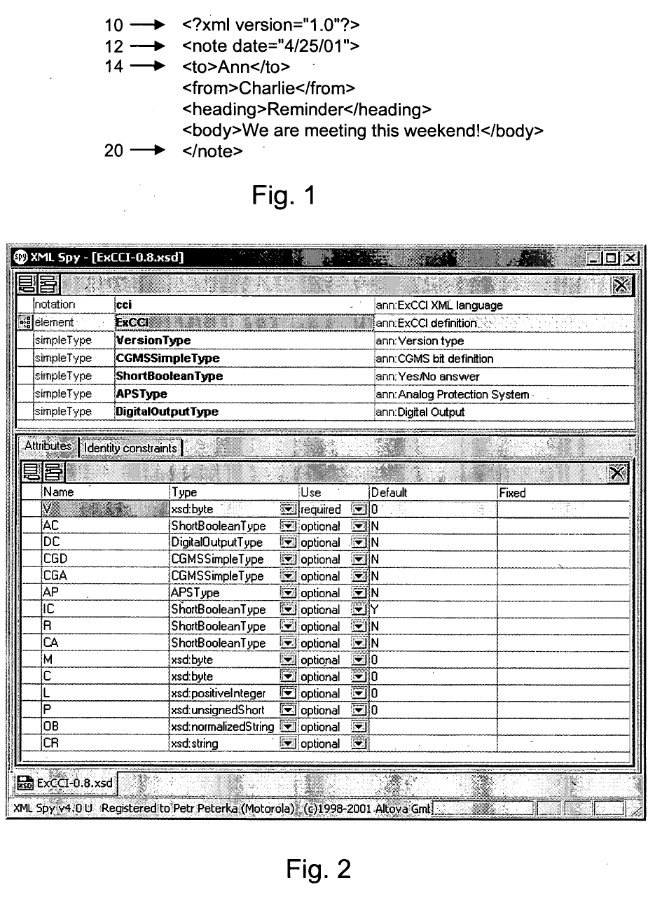

### DETAILED DESCRIPTION OF THE INVENTION

A preferred embodiment of the invention provides for definition of standard DRM controls and other information, such as those in CCI or ExCCI, to be efficiently represented and processed by using standard definition languages such as XML and XrML. Although the invention is discussed primarily with reference to specific standard definitions and languages, other definitions, languages, schemas, and constructs can be employed. The following references are hereby incorporated by reference as if set forth in full in this document:

(1) Open Digital Rights Language (ODRL), version 1.0 (www.odr1.net)

(2) Extended Copy Control Information (EXCCI) Data Packet; Proposed SMPTE Standard for Television (W25.499-2466B)

(3) Open Mobile Alliance Rights Expression Language, version 1.0 (http://www.openmobilealliance.org/documents.htm1); and

(4) Extensible Rights Management Language, XrML (http://xrm1.org/).

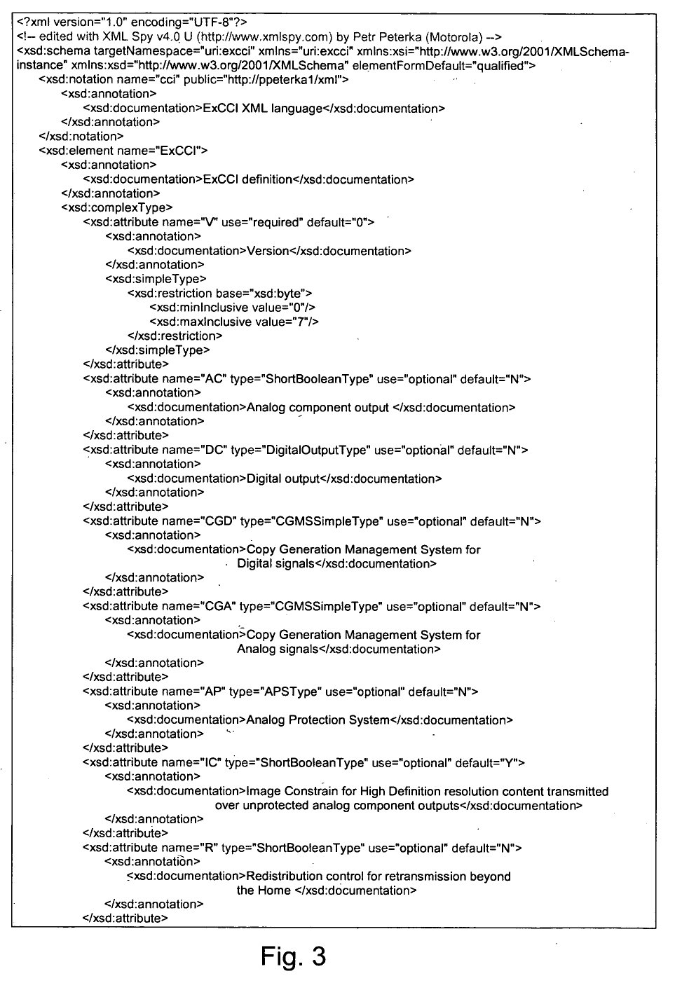

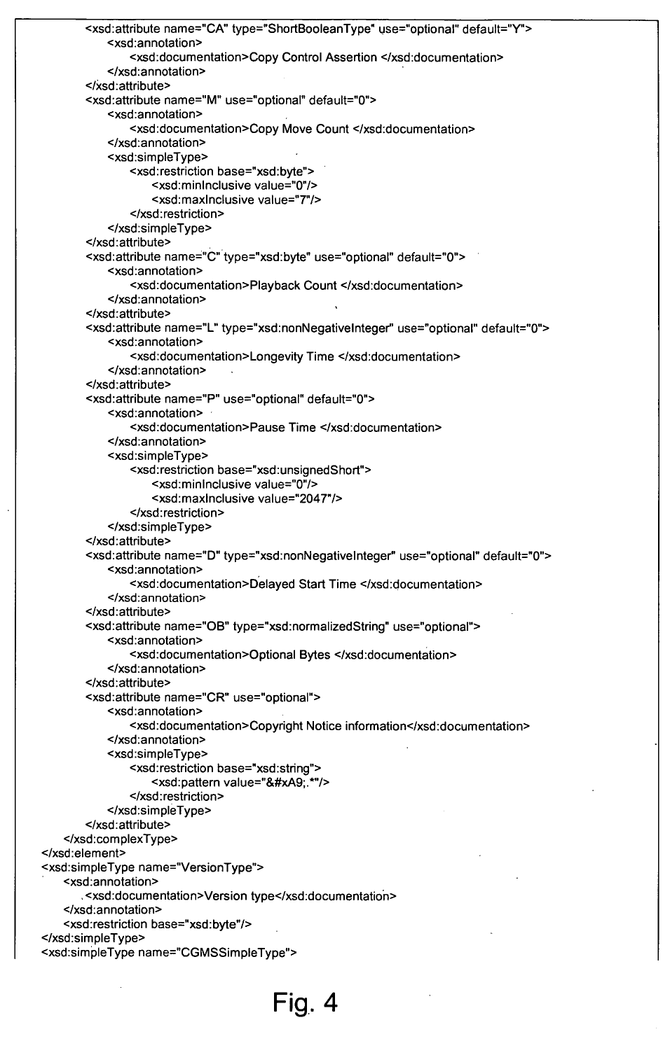

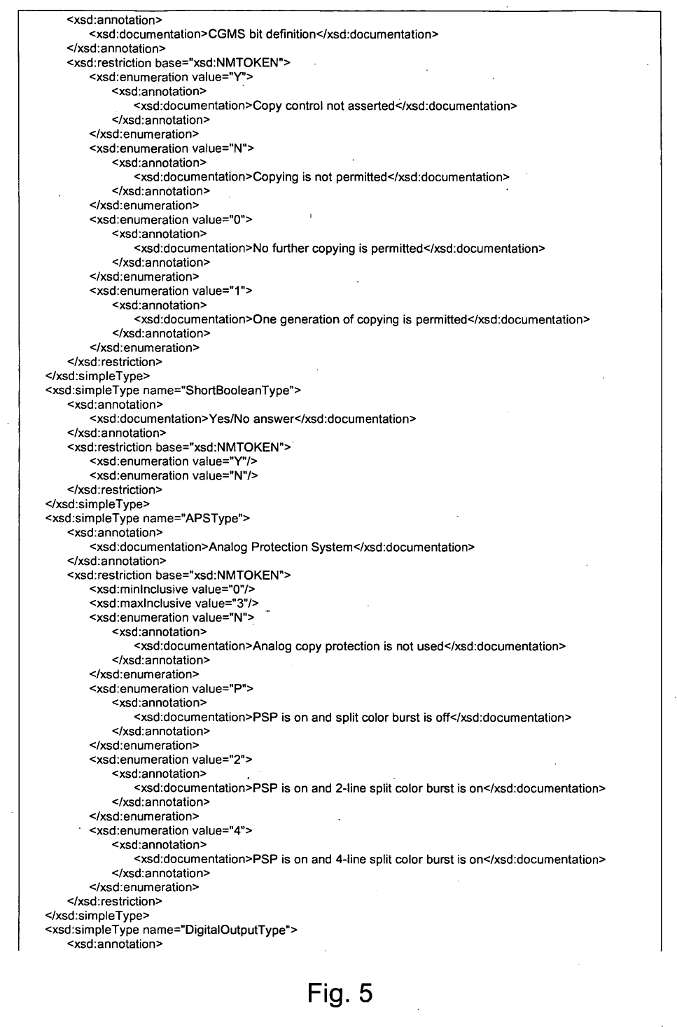

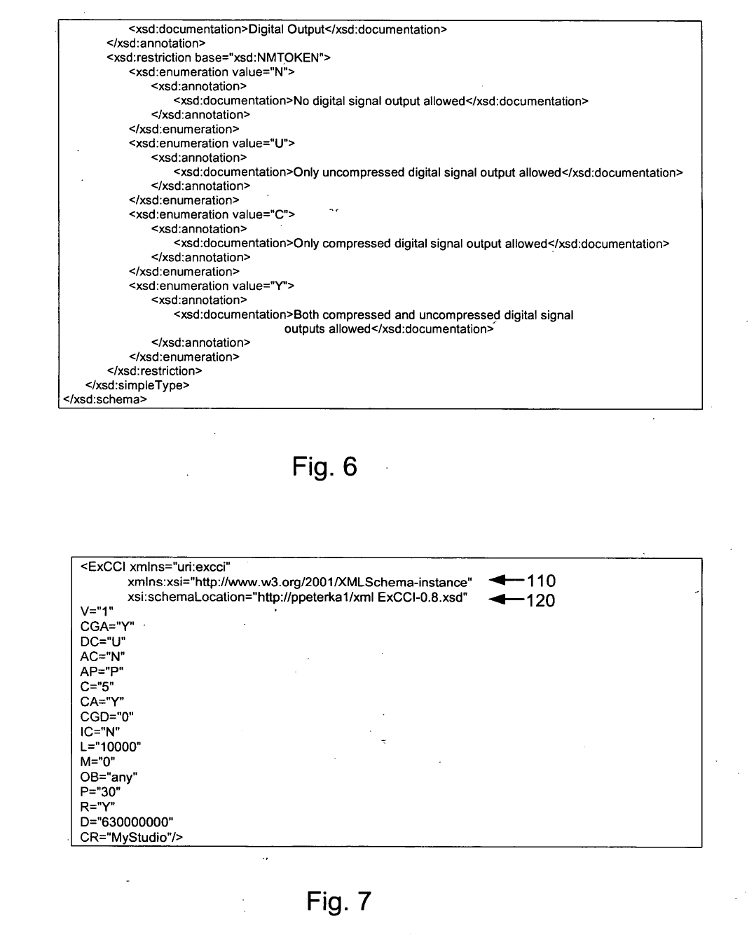

FIGS. 3-6 show a preferred embodiment XML schema that defines a language that can express ExCCI structures in the form of attributes, as opposed to elements. By using attribute representations rather than elements, space is conserved. By using attribute names and a schema structure that parallels the ExCCI definition an author, viewer, or other user of definitions created using the language can easily interpret the ExCCI XML expressions. Note that other embodiments may use different names and can include more or less structures as attribute or element definitions, as desired. In FIGS. 3-6, many of the attributes are defined as optional or have default values so that if their use is not required, the resulting definition (and the XML file) is smaller. Default values may be chosen based on the expected most probable use of each attribute to minimize the number of attributes that must be explicitly included.

The schema of FIGS. 3-6, and similar schemas, can be generated with the assistance of authoring tools such as an XML development environment. Other embodiments can use any suitable tools for generating, deriving, or processing XML schema, definitions or other constructs. For example, a simple text editor may also be used.

FIG. 2 shows a screen from the XML development environment that includes concise abbreviations for different structures in ExCCI, and that was used to generate the schema of FIGS. 3-6. In FIG. 2, the major structure of ExCCI is encoded as an element and individual bits of ExCCI, or combinations of bits within the structure, are encoded as attributes of the elements. Short names are used to conserve space in both the human-readable definition and in any associated machine-readable electronic representation.

TABLE I

AC = Analog Component
DC = Digital Output
CGD = Copy Generation Management System for Digital content
CGA = Copy Generation Management System for Analog content
AP = Analog Protection System
IC = Image Constrain
R = Retransmission
CA = Copy Control Assertion
M = Move count
C = Playback Count
L = Longevity Time
P = Pause Time
D = Delayed Start Time
OB = Optional Bytes
CR = Copyright Notice
Y = Yes
N = No

FIG. 7 shows an XML file defined using the schema of FIGS. 3-6. In the XML file of FIG. 7, many of the ExCCI attributes are set. Note that if schema validation is not required, the definitions at lines 110 and 120 do not have to be included. The omission of these lines will significantly reduce the size of the XML file. Also, if not all ExCCI controls are used, or if default values are used, the corresponding attributes do not have to be included in the XML document. Finally, the ASCII format may be compressed resulting in a final size comparable to the size of the standard ExCCI (64 bytes as in the current SMPTE draft of a new version of EXCCI).

The XML file of FIG. 7 uses shorthand abbreviations that are easily understood by an author or a reader. For example, the attribute “V” stands for “version” and is assigned the value of “1”. “CGA” stands for “Copy Generation Management System for Analog Signals” and is set to “Y”, or “yes”. Note that attributes that are not explicitly assigned values in an XML file are given default values, thus further simplifying the file and reducing the amount of information that needs to be included in the file. For example, the “AC” attribute (“Analog component output”) is not defined in the XML file in FIG. 7, and so is assigned the default value as shown in the XML schema of FIG. 3, as “N”, or “no”.

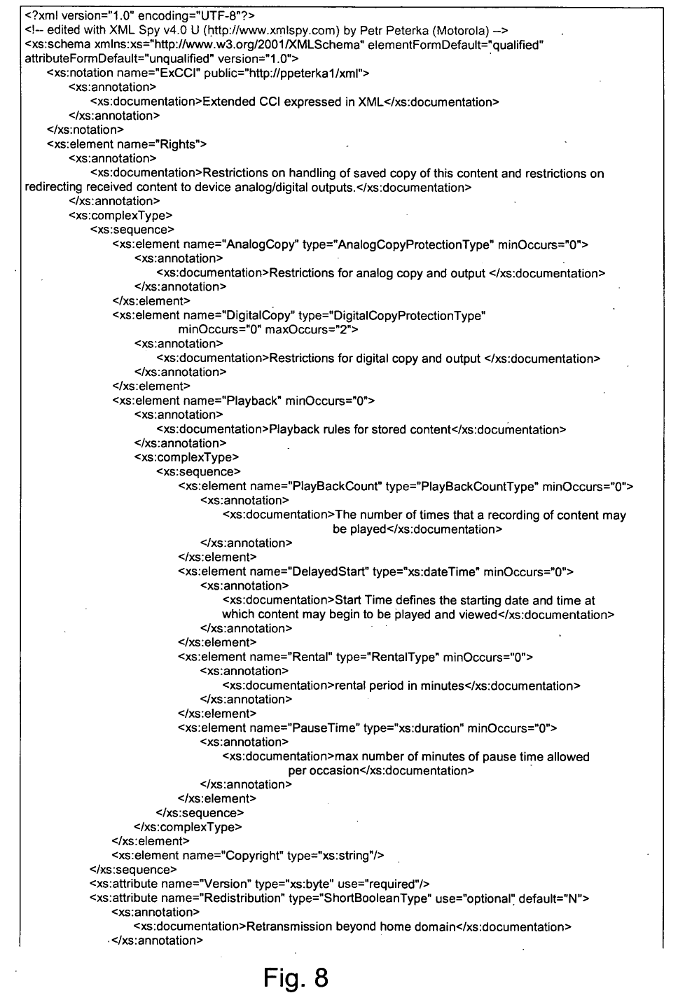

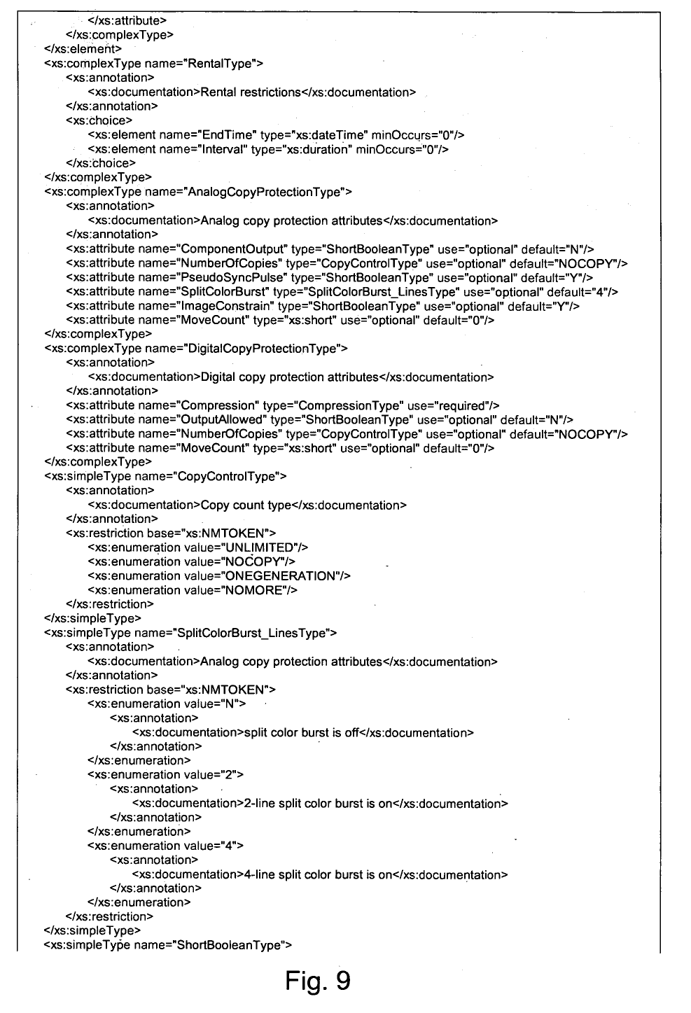

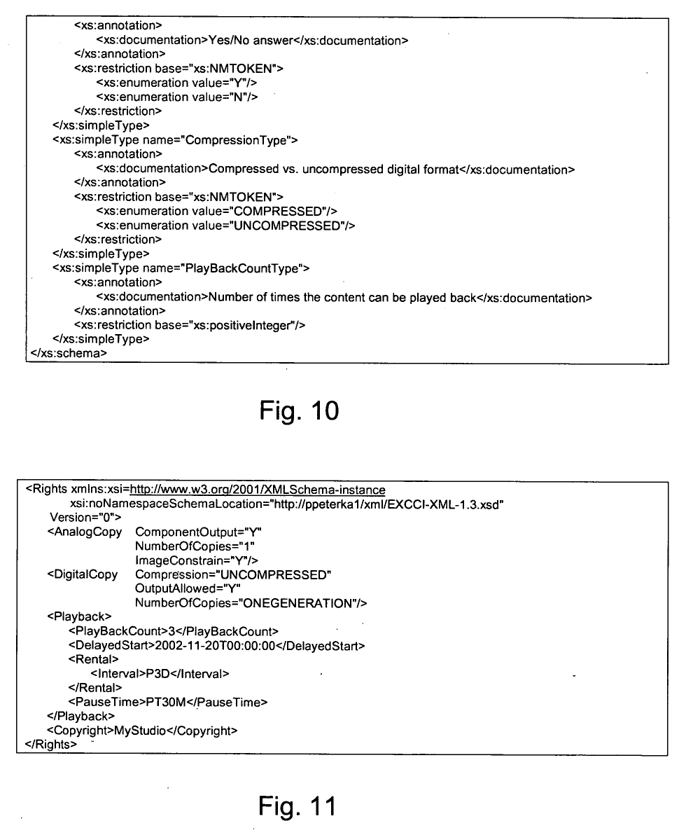

Another embodiment of the invention provides a more descriptive version of an ExCCI file in XML. FIGS. 8-10 show the descriptive ExCCI schema.

FIG. 11 illustrates an ExCCI definition written using the ExCCI schema of FIGS. 8-10. Note that the definition in FIG. 11 is more lengthy but also more immediately readable than the definition of FIG. 7 which used the concise ExCCI schema of FIGS. 3-6. The definition can be made more compact by reliance on default values so that all of the value assignments in FIG. 11 do not have to be made. For example, the AnalogCopy element has a numberOfCopies attribute which may be set to NOCOPY as a default value.

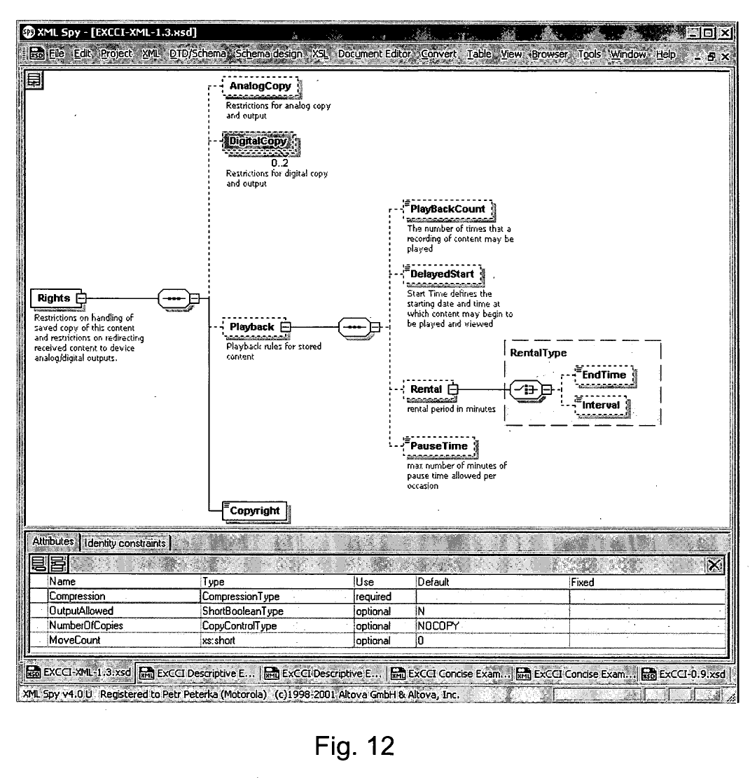

FIG. 12 is a graphical depiction of ExCCI rights associated with digital content. For example, a “DigitalCopy” element describes restrictions relating to making digital copies. The DigitalCopy element can be expanded to show detailed restrictions such as how many copies can be made, whether compressed vs. uncompressed copies can be made, etc. The AnalogCopy element is a similar right but relates to making copies over analog interfaces. The Playback right allows a user to view the content with further restrictions such as a maximum number of playbacks, start time when a user can begin playback, end time or number of days of how long a user can keep the content (i.e., renting) and how long the content can be paused. The copyright element has information about the copyright holder for the associated piece of content.

Existing DRM languages, such as Open Digital Rights Language (ODRL), can be used and/or extended to express ExCCI rules. A preferred embodiment of the invention allows ExCCI to be expressed in a subset of ODRL language as defined by OMA by adding the additional permissions and constraints shown in Table II. Other embodiments can use different amounts and types of additions or modifications.

TABLE II

Extended Permissions
Duplicate - to make a copy of a piece of content
Move - to move a piece of content without making a copy
Pause - to pause while playing or otherwise consuming a
piece of content
Give - to support the ExCCI concept of retransmission
Extended Constraints
Format - to specify analog, digital compressed and uncompressed
content formats
Quality - to restrict HD content to 600 vertical pixels
Protection - to specify details of analog copy protection
mechanisms

A similar mapping and possible extension could be done for the XrML, language discussed in MPEG, TVAnytime and by other standards organizations.

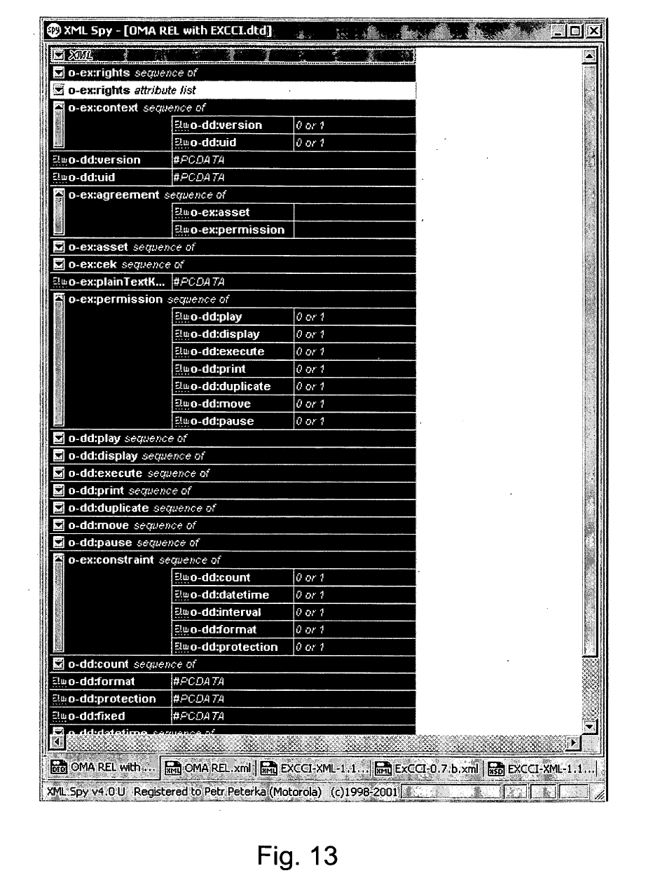

FIG. 13 is a graphical representation of a Data Type Definition (DTD) of Open Mobile Alliance (OMA) REL extended to support ExCCI. OMA uses a subset of ODRL to define a Rights Expression Language for mobile applications.

ODRL is currently used by OMA to define a rights expression language (REL) for mobile phones that is based on a subset of ODRL. The OMA REL is used here as a convenient example. Since version 1 of the OMA REL specification does not define an XML Schema but rather a DTD the DTD format is used here. Other embodiments can use other formats, such as an XML schema format.

Descriptions of a current version of the ODRL language can be found at in related Expression Language and Data Dictionary documents at http://odr1.net/1.1/ODRL-EX-11.xsd and http://odr1.net/1.1/ODRL-DD-11.xsd, respectively.

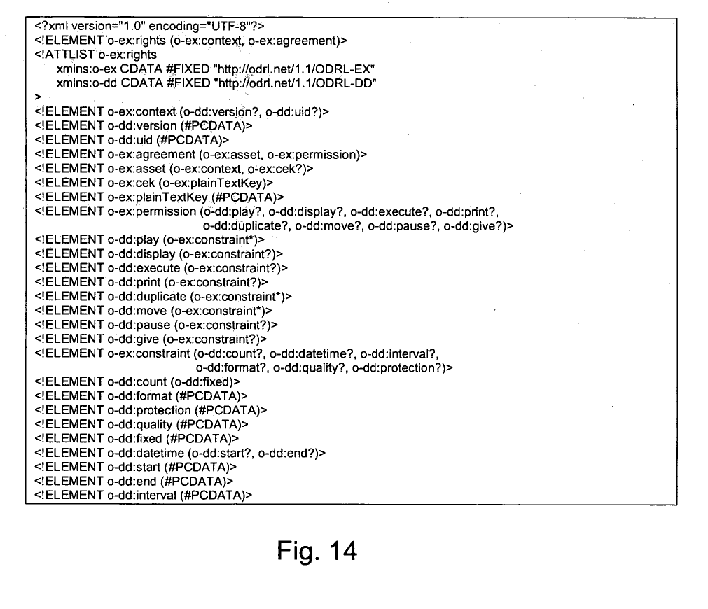

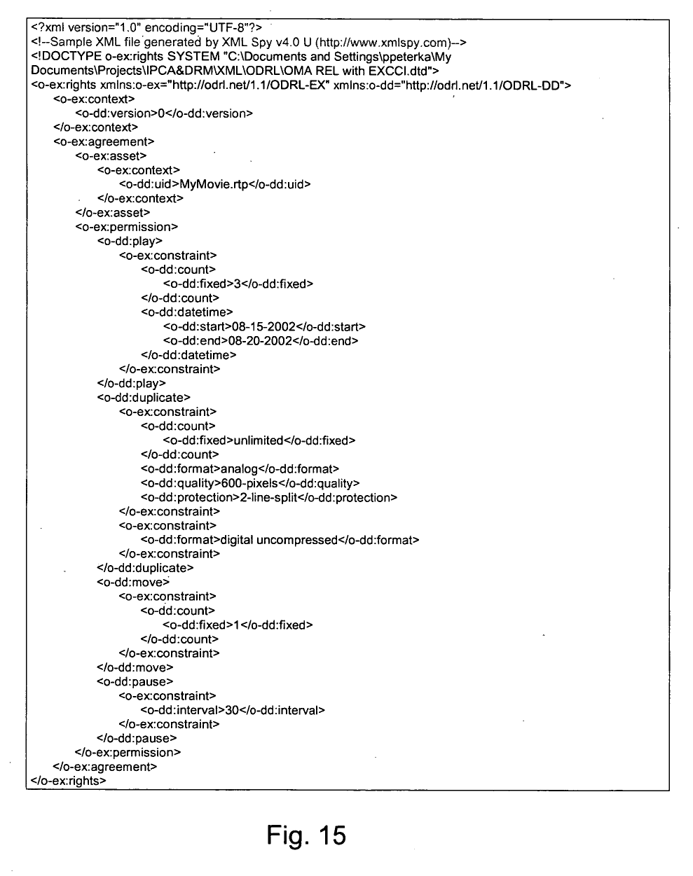

FIG. 14 shows an OMA REL definition used in a preferred embodiment of the invention. In FIG. 14, the definition is extended by the permissions and constraints listed in Table III.

Note that the OMA subset of ODRL does not include the concept of a “party” which could be used to map the copyright holder information from ExCCI. Such missing ExCCI features can be added by supporting ODRL elements.

Additional details of extending ODRL in order to express more ExCCI settings are described in Table III. Table III gives an example of how individual ExCCI bits could be expressed in ODRL. The name under the ODRL heading is a name of an ODRL element. Element names in curly braces signify elements that are added to ODRL to more completely express ExCCI.

TABLE III
[BEGIN TABLE III]

| ExCCI: Version | | |
|---|---|---|
| ODRL: | | Context - Version |
| ExCCI: Analog Component | | |
| The ‘AC’ bit shall convey whether the content can be output using a | | |
| target device's analog component outputs as follows: | | |
| AC | | |
| | 0 | Analog component output not allowed. |
| | 1 | Analog component output allowed. |
| ODRL: | | Permission - Play (This assumes that AC is meant for |
| | | rendering content via an analog connection to a rendering |
| | | device.) |
| | | Constraint - Format: {Analog} |
| ExCCI: Digital Output | | |
| The ‘DC1’ and ‘DC0’ bits shall convey whether the content can be | | |
| output using a target device's digital outputs as follows: | | |
| DC1 | DC0 | |
| 0 | 0 | No digital signal output allowed. |
| 0 | 1 | Only uncompressed digital signal output allowed. |
| 1 | 0 | Only compressed digital signal output allowed. |
| 1 | 1 | Both compressed and uncompressed digital signal |
| | | outputs allowed. |
| ODRL: | | Permission - Play (This assumes that AC is meant for |
| | | rendering content via an digital connection to a rendering |
| | | device.) |
| | | Constraint - Format: {Digital Compressed, Digital |
| | Uncompressed} | |
| ExCCI: Copy Generation Management System for Analog signals | | |
| The ‘CGMS-A’ bits shall convey the following meanings: | | |
| b1 | b0 | |
| 0 | 0 | Copy control not asserted, unauthorized retransmission |
| | | outside the home not permitted. |
| 0 | 1 | No further copying is permitted. |
| 1 | 0 | One generation of copying is permitted. |
| 1 | 1 | Copying is not permitted. |
| ODRL: | | Permission - Duplicate |
| | | Constraint - Format: {Analog} |
| | | Constraint - Count |
| ExCCI: Copy Generation Management System for Digital content | | |
| The ‘CGMS-D’ bits are the equivalent of the CGMS-A bits and have | | |
| definitions corresponding to those defined for the CGMS-A bits. The | | |
| CGMS-D bits shall convey the following meanings: | | |
| b1 | b0 | |
| 0 | 0 | Copy control not asserted, unauthorized retransmission |
| | | outside the home not permitted. |
| 0 | 1 | No further copying is permitted. |
| 1 | 0 | One generation of copying is permitted. |
| 1 | 1 | Copying is not permitted. |
| ODRL: | | Permission - Duplicate |
| | | Constraint - Format: {Digital} |
| | | Constraint - Count |
| ExCCI: Analog Protection System | | |
| The ‘APS’ bits shall convey the type of analog copy protection to be | | |
| applied by the target output device, but only if CGMS-A bit 0 is equal to | | |
| 1. The ‘APS’ bits shall have the following meaning: | | |
| b1 | b0 | |
| 0 | 0 | Analog copy protection is not used. |
| 0 | 1 | PSP is on & split color burst is off. |
| 1 | 0 | PSP is on & 2-line split color burst is on. |
| 1 | 1 | PSP is on & 4-line split color burst is on. |

| | |
|---|---|
| ODRL: | P rmission - Duplicate |

Constraint - F rmat: {Analog}
Constraint - {Protection System: PSP, 2-line split, 4-

line split}

ExCCI: Image Constrain
The ‘IC’ bit conveys information about whether High Definition
resolution content must be image-constrained to no greater than 600
vertical pixels (standard definition resolution) when being transmitted
over unprotected analog component outputs. The two states of the ‘IC’
bit shall have the following meanings:
IC

| 0 | High Definition resolution content need not be image |
|---|---|
| | constrained when being transmitted over unprotected analog |
| | component outputs. |
| 1 | High Definition resolution content must be image constrained |

to no greater than 600 vertical pixels when being transmitted
over unprotected analog component outputs.

| | |
|---|---|
| ODRL: | Permission - Play, Duplicate |

Constraint - Format: {Analog}
Constraint - Format or Quality: {600 vertical pixels}

| ExCCI: Retransmission | |
|---|---|
| The ‘R’ bit is the Retransmission bit and allows content owners to mark | |
| their content to restrict its retransmission beyond the Home. It shall | |
| have the following meaning: | |
| R | |
| 0 | The content may not be retransmitted beyond the Home. |
| 1 | The content may be retransmitted beyond the Home |

| | |
|---|---|
| ODRL: | Permission - Give |

| ExCCI: Copy Control Assertion | |
|---|---|
| The ‘CCA’ has been added to allow content owners to mark their | |
| content using existing 2-bit CCI data to trigger content encryption. But | |
| once the content is decrypted and the content's ExCCI read, the ‘CCA’ | |
| bit conveys information concerning whether copy control is being | |
| asserted by the content owner. The ‘CCA” bit has the following | |
| meaning: | |
| CCA | |
| 0 | Copy control is not asserted, regardless of CGMS data. |
| 1 | Copy control is asserted. |

| | |
|---|---|
| ODRL: | No ODRL equivalent is needed |

| ExCCI: Copy Move Count | |
|---|---|
| The ‘M2’, ‘M1’, and ‘M0’ bits define an integer value ‘M’ that ranges | |
| from 0 to 7 and represents the number of times that a copy made of | |
| Copy Once content may be moved from one recording medium to | |
| another so long as the original recording is erased and/or made no | |
| longer accessible. The Copy Move Count value ‘M’ shall have the | |
| following meanings: | |
| M = 0 | A copy made of Copy Once content may not (or may no |

longer) be moved.

| | |
|---|---|
| M = 1 to 6 | Number of times that a copy of Copy Once content may |

| | be moved. |
|---|---|
| M = 7 | A copy made of Copy Once content may be moved an unlimited |

number of times.

| ODRL: | Permission - Move |
|---|---|
| | Constraint - Count |
| ExCCI: Playback Count | |
| The Playback Count byte defines an integer value ‘C’ that represents | |
| the number of times that a temporary recording of content may be | |
| played during the Longevity period. The Playback Count value ‘C’ shall | |
| have the following meanings: | |
| C = 0 | The temporary content recording may no longer be |
| | played. |
| C = 1 to 254 | Number of times the temporary content recording may be |
| | played during the Longevity period. |
| C = 255 | The temporary content recording may be played an |
| | unlimited number of times during the Longevity period. |
| ODRL: | Permission - Play |
| | Constraint - Count |
| ExCCI: Longevity Time | |
| The Longevity Time bits define the number of minutes during which a | |
| temporary recording of content may be played. The Longevity Time | |
| value ‘L’ shall have the following meanings: | |
| L = all 0s | The temporary content recording may no longer be |
| | played. |
| L = neither all 1s Number of minutes the temporary content recording | |
| | may still be played, |
| | nor all Os provided the Playback Count value ‘C’ =>1. |
| L = all 1s | The temporary content recording may be played |
| | indefinitely, provided the Playback Count value ‘C’ >=1. |
| ODRL: | Permission - Play (or other applicable permissions) |
| | Constraint - Interval |
| | Constraint - Date Time |
| ExCCI: Pause Time | |
| The Pause Time bits define the maximum number of minutes per | |
| occasion that a temporary recording of content may be paused during | |
| PVR recording or viewing. The Pause Time value ‘P’ shall have the | |
| following meanings: | |
| P = all 0s | The temporary content recording may not be paused. |

P = neither all 1s Maximum number of minutes per occasion that the

| temporary | |
|---|---|
| nor all 0s | content recording may be paused. |

| P = all 1s | The temporary content recording may be paused |
|---|---|
| | indefinitely. |
| ODRL: | Permission - {Pause} |

Constraint - Interval

| ExCCI: Delayed Start Time | |
|---|---|
| The Start Time bits define the starting date and time at which a | |
| temporary content recording may begin to be played and viewed. | |
| S = 0 | The start time mechanism is not being used, and the start time |

reference for Longevity is the time when the content was
received.

| ODRL: | Permission - Play (or other applicable permissions) |
|---|---|
| | Constraint - Date Time: start |
| ExCCI: Optional Bytes | |
| ODRL: | Context - Remark |
| ExCCI: Copyright Notice Information | |
| ODRL: | Party - Rights Holder |

[END TABLE III]

Although the invention has been discussed with reference to specific embodiments thereof, these embodiments are illustrative, and not restrictive, of the invention. For example, although schemas or definitions include specific structures or data constructs such as elements, attributes, values, etc., other schemas or definitions that use different constructs may be employed.

An indicator can be, or include, any type of information representation such as a bit, byte, word, or other group or arrangement of bits. Any type of data representation can be used such as a flag, variable, array, attribute, value, index, pointer, etc. Any format for data representation may be used such as packed bits, integer, floating point, etc. The invention is not limited to the particular type, number, arrangement or other characteristics of indicators used to describe the specific embodiments as other suitable indicators can be used.

Once defined, a definition can be written, read, transferred or otherwise processed by a hardware device or software process. A definition can be translated or compiled into another form. For example, any bit, byte, word, or data structure approach can be used to represent the definition. The definition can be compressed, encoded, encrypted or subjected to other modification during processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable carrier” for purposes of embodiments of the present invention may be any medium or transmission that can contain, store, communicate, propagate, or transport the program for use by or in connection with the instruction execution system, apparatus, system or device. The computer readable carrier can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be-included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in the following claims and/or to the particular embodiment disclosed as the best mode contemplated for carrying out this invention, but that the invention will include any and all embodiments and equivalents falling within the scope of the appended claims.

What is claimed is:

1. A method for writing a definition of extended copy control information (ExCCI) in a language, the language comprising elements having data, and further comprising attributes associated with an element, wherein an attribute can have an associated value, the ExCCI including indicators, the method comprising
using the attributes to represent a substantial amount of the ExCCI indicators to define a schema of ExCCI in the language; and
using the schema to create an ExCCI definition wherein the ExCCI indicators are assigned values.

2. The method of claim 1, wherein a given indicator is associated with a default value, the method further comprising
determining that the given indicator is not assigned a value; and
assigning a predetermined default value to the given indicator.

3. The method of claim 1, wherein the definition includes Copy Control Information (CCI).

4. The method of claim 1, wherein the language includes Extensible Markup Language (XML).

5. The method of claim 1, wherein the language includes Extensible Rights Markup Language (XrML).

6. The method of claim 5, further comprising
defining one or more extensions.

7. The method of claim 1, wherein the language includes Open Digital Rights Language (ODRL).

8. The method of claim 7, further comprising
defining one or more extensions as one or more of “Duplicate,” “Move,” “Pause,” or “Give” permissions; or one or more of “Format,” “Quality” or “Protection” constraints.

9. The method of claim 1, wherein the language includes Open Mobile Alliance (OMA) Rights Expression Language (REL).

10. The method of claim 9, further comprising
defining one or more extensions as one or more of “Duplicate,” “Move,” “Pause,” or “Give” permissions; or one or more of “Format,” “Quality” or “Protection” constraints.

11. The method of claim 1, wherein ExCCI indicator names are used for attribute names, and wherein ExCCI value are represented by attribute values.

12. The method of claim 11, wherein ExCCI indicator name abbreviations are used.

13. An apparatus for writing a definition of extended copy control information (ExCCI) in a language, the language comprising elements having data, and further comprising attributes associated with an element, wherein an attribute can have an associated value, the ExCCI including indicators, the apparatus comprising
a processor for executing instructions stored in a computer-readable medium;
one or more instructions for using the attributes to represent a substantial amount of the ExCCI indicators to define an element in a schema of ExCCI in the language; and
one or more instructions for using elements to represent a substantial amount of the ExCCI indicators to define a schema of ExCCI in the language; and
one or more instructions for using the schema to create an ExCCI definition wherein the ExCCI indicators are assigned values of the elements and the attributes.

14. A computer-readable medium including instructions for writing a definition of extended copy control information (ExCCI) in a language, the language comprising elements having data, and further comprising attributes associated with an element, wherein an attribute can have an associated value, the ExCCI including indicators, the computer-readable medium including
one or more instructions for using the attributes to represent a substantial amount of the ExCCI indicators to define a schema of ExCCI in the language;
one or more instructions for using elements to represent a substantial amount of the ExCCI indicators to define a schema of ExCCI in the language; and
one or more instructions for using the schema to create an ExCCI definition wherein the ExCCI indicators are assigned values of the elements and the attributes.
